(19) United States
(12) Patent Application Publication
(10) Pub. No.: US 2026/0360613 A1
(43) Pub. Date: Nov. 12, 2026

(54) COIL COMPONENT

(71) Applicant: TDK Corporation, Tokyo (JP)

(72) Inventors: Masashi SHIMOYASU, Tokyo (JP); Masataka YAMAMOTO, Tokyo (JP); Emiri HOSOYA, Tokyo (JP); Seiji OSADA, Akita (JP); Daiki KATO, Tokyo (JP); Junya OKAZAKI, Tokyo (JP); Yuto MURAKAMI, Tokyo (JP); Haruto TAKAKUWA, Tokyo (JP)

(73) Assignee: TDK Corporation, Tokyo (JP)

(21) Appl. No.: 19/665,884

(22) Filed: May 1, 2026

(30) Foreign Application Priority Data
May 9, 2025 (JP) 2025-078630

(51) Int. Cl. H01F 27/30; H01F 17/02

(52) U.S. Cl. CPC H01F 27/30; H01F 17/02

(57) ABSTRACT

A coil component includes an element body, a coil disposed in the element body, and a stress relief portion located within the element body. The coil includes an internal conductor that extends along a plane. The stress relief portion is in contact with the internal conductor and is configured to relieve internal stress in the element body. The internal conductor includes, in a cross-section orthogonal to an extending direction of the internal conductor, a pair of main surfaces opposing each other in a direction orthogonal to the plane, and a pair of side surfaces extending between the pair of main surfaces. The stress relief portion includes a pair of stress relief regions each in contact with a corresponding main surface of the pair of main surfaces. Each of the pair of side surfaces is, at least in part, in contact with the element body.

### CROSS-REFERENCE TO RELATED APPLICATIONS

This application is based upon and claims the benefit of priority from Japanese Patent Application No. 2025-078630, filed on May 9, 2025, the entire contents of which are incorporated herein by reference.

### BACKGROUND

### Field

An aspect of the present disclosure relates to a coil component.

### Description of the Related Art

Known coil components include an element body and a coil that is disposed in the element body and includes an internal conductor extending along a plane (see, for example, International Publication No. 2011/108701).

### SUMMARY

A coil component according to an aspect of the present disclosure includes an element body, a coil disposed in the element body and including an internal conductor that extends along a plane, and a stress relief portion in contact with the internal conductor, located within the element body, and configured to relieve internal stress in the element body. The internal conductor includes, in a cross-section orthogonal to an extending direction of the internal conductor, a pair of main surfaces opposing each other in a direction orthogonal to the plane, and a pair of side surfaces extending between the pair of main surfaces. The stress relief portion includes a pair of stress relief regions each in contact with a corresponding main surface of the pair of main surfaces. Each of the pair of side surfaces is, at least in part, in contact with the element body.

### BRIEF DESCRIPTION OF THE DRAWINGS

FIG. 1 is a perspective view illustrating a coil component according to an example;

FIG. 2 is a view illustrating a cross-sectional configuration of the coil component according to the example;

FIG. 3 is a view illustrating a cross-sectional configuration of the coil component according to the example;

FIG. 4 is a view illustrating a cross-sectional configuration of the coil component according to the example;

FIG. 5 is an exploded plan view illustrating the coil component according to the example;

FIG. 6 is a view illustrating a cross-sectional configuration of a coil conductor;

FIG. 7 is a view illustrating a cross-sectional configuration of a coil component according to a modification of the example;

FIG. 8 is a view illustrating a cross-sectional configuration of a coil component according to another modification of the example;

FIGS. 9A - 9C are views illustrating cross-sectional configurations of coil conductors; and

FIGS. 10A - 10F are schematic views illustrating an example of a manufacturing process of a coil component.

### DETAILED DESCRIPTION

Hereinafter, various examples of the present disclosure will be described in detail, including examples illustrated in the accompanying drawings. In the following description, with reference to the drawings, the same reference numbers are assigned to the same components or to similar components having the same function, and overlapping description is omitted.

An aspect of the present disclosure provides a coil component that suppresses occurrence of cracks in an element body and an increase in direct current resistance.

An aspect of the present disclosure relates to a coil component that includes an element body, a coil disposed in the element body and including an internal conductor that extends along a plane, and a stress relief portion in contact with the internal conductor, located within the element body, and configured to relieve internal stress in the element body. The internal conductor includes, in a cross-section orthogonal to an extending direction of the internal conductor, a pair of main surfaces opposing each other in a direction orthogonal to the plane, and a pair of side surfaces extending between the pair of main surfaces. The stress relief portion includes a pair of stress relief regions each in contact with a corresponding main surface of the pair of main surfaces. Each of the pair of side surfaces is, at least in part, in contact with the element body.

In a coil component including an element body and a coil, cracks may occur in the element body due to internal stress generated in the element body. The internal stress is generated, for example, by shrinkage of an internal conductor included in the coil when the internal conductor is formed during the manufacturing process of the coil component. Due to the shrinkage of the internal conductor, a force in a direction in which the internal conductor pulls the element body is generated in the element body.

In contrast, in the aspect described above, each of the pair of stress relief regions is in contact with a corresponding main surface of the pair of main surfaces included in the internal conductor. Therefore, on the main surface side of the internal conductor, a force in a direction in which the internal conductor pulls the element body tends not to be generated in the element body. Consequently, the aspect described above reduces the internal stress in the element body and suppresses occurrence of cracks in the element body.

The shrinkage of the internal conductor described above may affect a cross-sectional area of the internal conductor. That is, the cross-sectional area of the internal conductor may decrease. A decrease in a cross-sectional area of the internal conductor increases direct current resistance of the coil.

In contrast, in the aspect described above, each of the pair of side surfaces included in the internal conductor is, at least in part, in contact with the element body. The element body tends to constrain the shrinkage of the internal conductor in a region in contact with the internal conductor. Therefore, the aspect described above suppresses the shrinkage of the internal conductor in a direction intersecting the side surfaces, thereby suppressing a decrease in the cross-sectional area of the internal conductor. Consequently, the aspect described above suppresses an increase in direct current resistance.

In the above aspect, each of the pair of side surfaces may be entirely in contact with the element body.

A configuration in which each of the pair of side surfaces is entirely in contact with the element body increases an area of a region, in the element body, that is in contact with the internal conductor. An increase in the area of the region, in the element body, that is in contact with the internal conductor enhances the tendency for the element body to constrain the shrinkage of the internal conductor. Therefore, this configuration further suppresses the decrease in the cross-sectional area of the internal conductor and further suppresses the increase in direct current resistance.

In the above aspect, each of the pair of side surfaces and a surface of the element body in contact with a corresponding side surface of the pair of side surfaces may have complementary uneven shapes in the cross-section orthogonal to the extending direction of the internal conductor.

In a configuration in which each of the pair of side surfaces and a surface of the element body in contact with a corresponding side surface of the pair of side surfaces have the uneven shape described above, the element body tends to further constrain the shrinkage of the internal conductor. Therefore, this configuration further suppresses the decrease in the cross-sectional area of the internal conductor and further suppresses the increase in direct current resistance.

In the above aspect, the internal conductor may include a plurality of coil conductors each extending along a different plane and each including the pair of main surfaces and the pair of side surfaces. Adjacent coil conductors of the plurality of coil conductors may be each connected to a connection conductor on a side of one main surface of the pair of main surfaces. The stress relief portion may include a stress relief region in contact with a region that corresponds to the connection conductor and that is included in the other main surface of the pair of main surfaces.

The connection conductor also shrinks during the manufacturing process of the coil component, similarly to the coil conductor. Therefore, a region that corresponds to the connection conductor and that is included in the other main surface tends to cause a larger force to be generated in the element body in a direction in which the conductor pulls the element body, compared to regions that are other than the region that corresponds to the connection conductor and that are included in the other main surface.

A configuration in which the stress relief portion includes the stress relief region in contact with the region corresponding to the connection conductor reliably reduces the internal stress in the element body. Therefore, this configuration reliably suppresses the occurrence of cracks in the element body.

In the above aspect, the internal conductor may include a plurality of coil conductors each extending along a different plane and each including the pair of main surfaces and the pair of side surfaces. Adjacent coil conductors of the plurality of coil conductors may be each connected to a connection conductor on a side of one main surface of the pair of main surfaces. The stress relief region in contact with the other main surface of the pair of main surfaces may be in contact with a region that corresponds to the connection conductor and that is included in the other main surface.

As described above, a region that corresponds to the connection conductor and that is included in the other main surface tends to cause a larger force to be generated in the element body in a direction in which the conductor pulls the element body, compared to regions that are other than the region that corresponds to the connection conductor and that are included in the other main surface.

A configuration in which the stress relief portion is in contact with the region corresponding to the connection conductor reliably reduces the internal stress in the element body. Therefore, this configuration reliably suppresses the occurrence of cracks in the element body.

In the above aspect, the internal conductor may include a plurality of coil conductors each extending along a different plane and each including the pair of main surfaces and the pair of side surfaces. Adjacent coil conductors of the plurality of coil conductors may be each connected to a connection conductor on a side of one main surface of the pair of main surfaces. A region that corresponds to the connection conductor and that is included in the other main surface of the pair of main surfaces need not be in contact with the stress relief region.

A configuration in which the region corresponding to the connection conductor is not in contact with the stress relief region increases the region, in the element body, that is in contact with the internal conductor. This configuration increases the region that constrains the shrinkage of the internal conductor. Therefore, this configuration further suppresses the decrease in the cross-sectional area of the internal conductor and further suppresses the increase in direct current resistance.

In the above aspect, the pair of stress relief regions may have different widths from each other.

In a configuration in which the pair of stress relief regions have the same width, a position of an end of the stress relief region in contact with one main surface of the pair of main surfaces and a position of an end of the stress relief region in contact with the other main surface of the pair of main surfaces tend to coincide with each other, in a view along a direction orthogonal to the plane. In a configuration in which the positions of the respective ends of the pair of stress relief regions coincide with each other, cracks may occur in the element body between the ends of the pair of stress relief regions.

In contrast, in a configuration in which the pair of stress relief regions have different widths from each other, the positions of the respective ends of the pair of stress relief regions tend not to coincide with each other, in a view along a direction orthogonal to the plane. Therefore, this configuration further suppresses the occurrence of cracks in the element body.

In the above aspect, the stress relief portion may include ZrO₂.

ZrO₂ has a high melting point and tends to exist in powder form. A configuration in which the stress relief portion includes ZrO₂ reliably relieves the internal stress in the element body.

In the above aspect, the element body may include a ferrite material.

In a configuration in which the element body includes a ferrite material, magnetic characteristics may change due to internal stress in the element body. The above aspect reduces the internal stress in the element body, as described above. Therefore, even in a configuration in which the element body includes a ferrite material, the magnetic characteristics tend not to change.

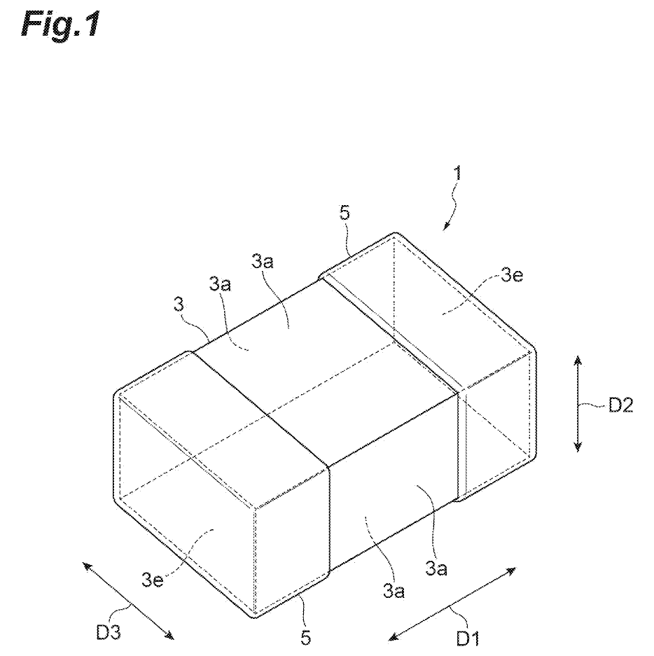

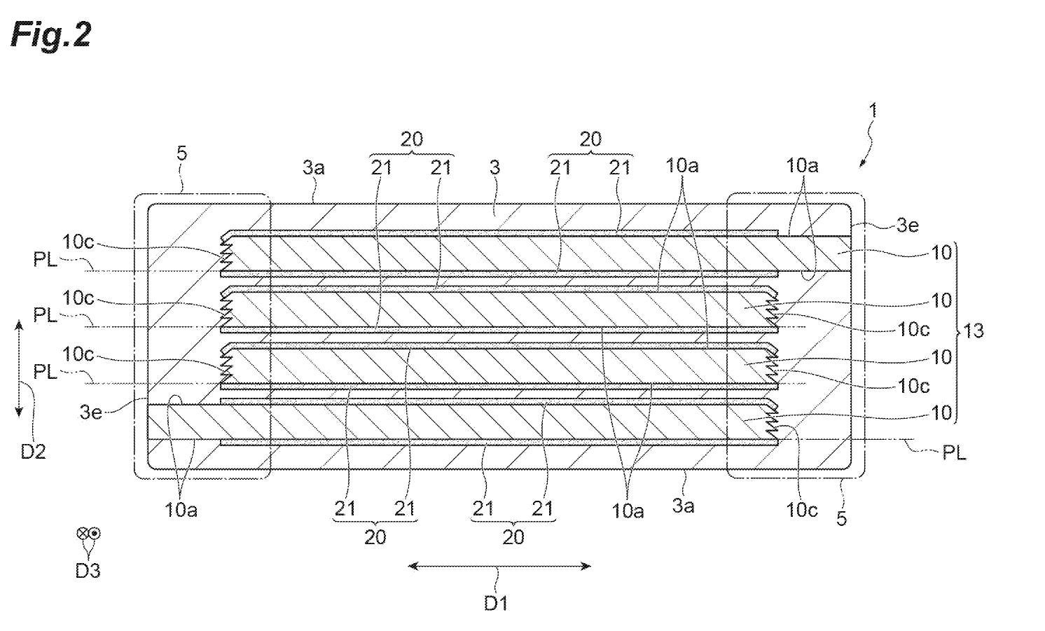

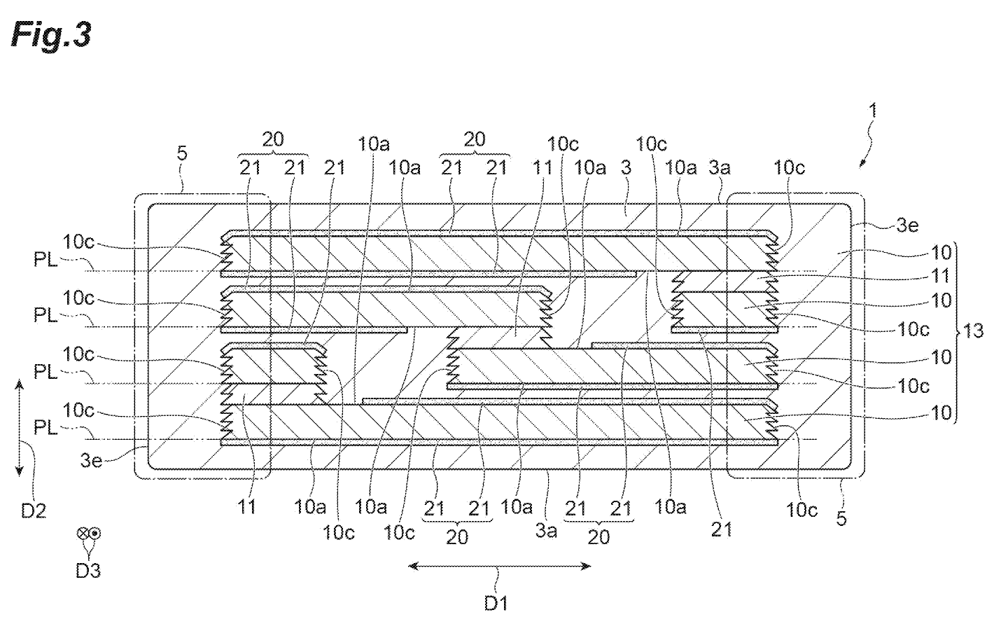

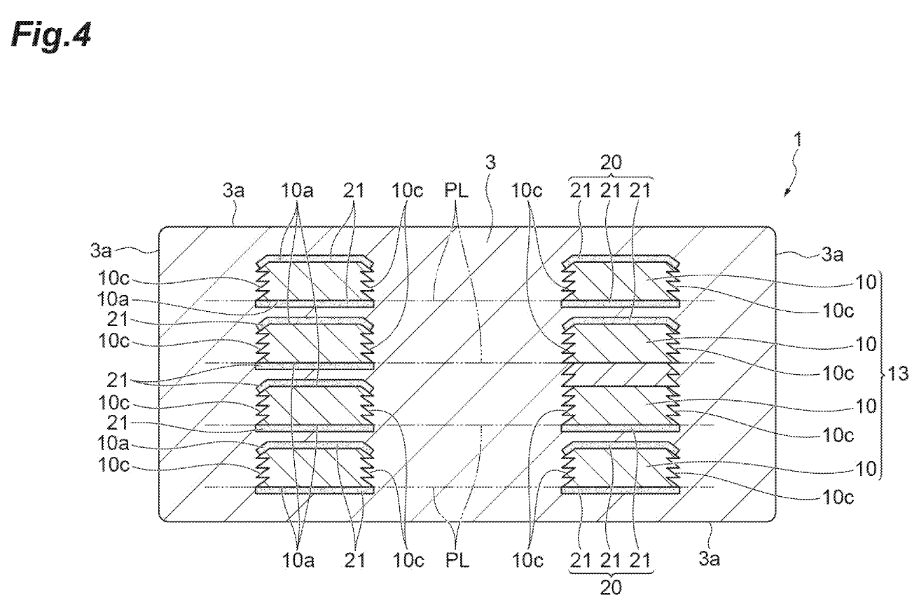

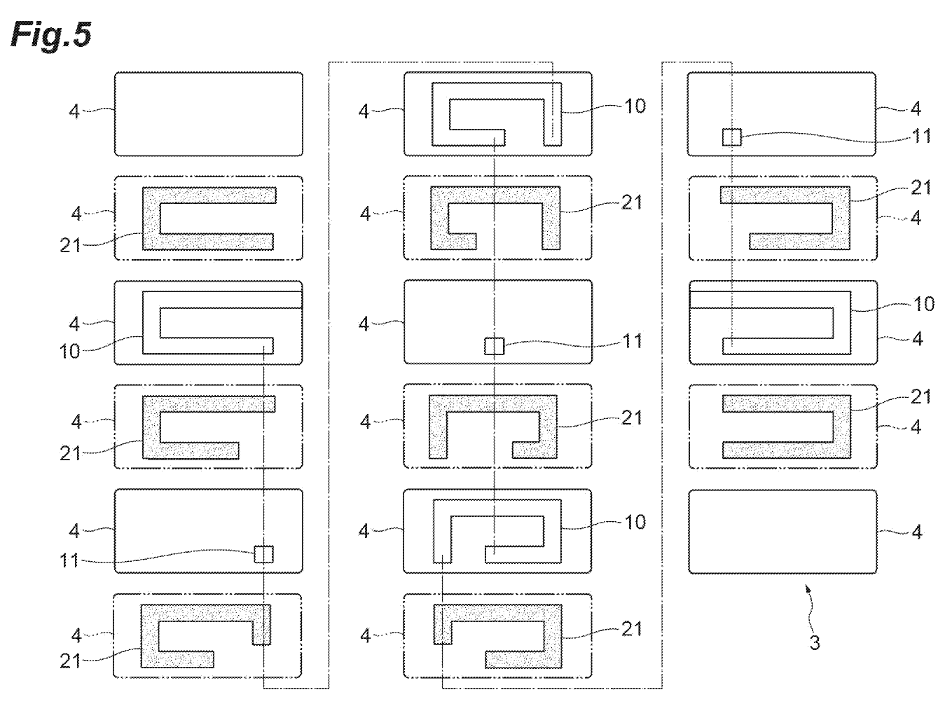

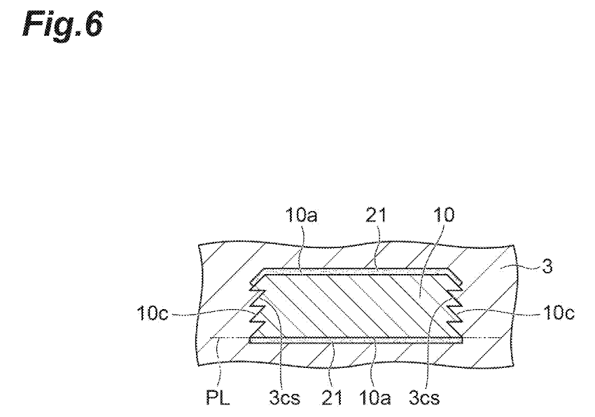

A configuration of a coil component 1 according to the example will be described with reference to FIGS. 1 - 6. FIG. 1 is a perspective view illustrating the coil component according to the example. FIGS. 2, 3, and 4 are views illustrating a cross-sectional configuration of the coil component according to the example. FIG. 5 is an exploded plan view illustrating the coil component according to the example. FIG. 6 is a view illustrating a cross-sectional configuration of a coil conductor.

The coil component 1 includes, for example, a multilayer coil component. The multilayer coil component includes, for example, a multilayer inductor or a multilayer bead.

The coil component 1 includes, as illustrated in FIG. 1, an element body 3 having a rectangular parallelepiped shape and a plurality of external electrodes 5. The coil component 1 includes, for example, a pair of external electrodes 5. The pair of external electrodes 5 are disposed on the element body 3. The pair of external electrodes 5 are spaced apart from each other. The rectangular parallelepiped shape includes, for example, a shape of a rectangular parallelepiped in which corners and ridges are chamfered, or a shape of a rectangular parallelepiped in which corners and ridges are rounded.

The element body 3 includes four side surfaces 3a and a pair of side surfaces 3e opposing each other. The four side surfaces 3a and the pair of side surfaces 3e have a rectangular shape. The rectangular shape includes, for example, a shape in which each corner is chamfered or a shape in which each corner is rounded. The four side surfaces 3a include a first pair of side surfaces 3a opposing each other and a second pair of side surfaces 3a opposing each other. A direction in which the first pair of side surfaces 3a oppose each other is a direction D2. A direction in which the second pair of side surfaces 3a oppose each other is a direction D3. A direction in which the pair of side surfaces 3e oppose each other is a direction D1.

The coil component 1 is solder-mounted on an electronic device. The electronic device includes, for example, a circuit board or another electronic component. In the coil component 1, one side surface 3a of the four side surfaces 3a opposes the electronic device. One side surface 3a of the four side surfaces 3a is arranged to constitute a mounting surface. One side surface 3a of the four side surfaces 3a is a mounting surface. For example, one of the first pair of side surfaces 3a is the mounting surface.

The direction D2 is a direction orthogonal to the first pair of side surfaces 3a and is orthogonal to the direction D3. The direction D1 is a direction parallel to both the first pair of side surfaces 3a and the second pair of side surfaces 3a, and is orthogonal to both the direction D2 and the direction D3. The direction D3 is a direction orthogonal to the second pair of side surfaces 3a, and the direction D1 is a direction orthogonal to the pair of side surfaces 3e.

The first pair of side surfaces 3a extend in the direction D3 to couple the second pair of side surfaces 3a to each other. The first pair of side surfaces 3a extend in the direction D1. The second pair of side surfaces 3a extend in the direction D2 to couple the first pair of side surfaces 3a to each other. The second pair of side surfaces 3a extend in the direction D1. The pair of side surfaces 3e extend in the direction D2 to couple the first pair of side surfaces 3a to each other. The pair of side surfaces 3e extend in the direction D3 to couple the second pair of side surfaces 3a to each other.

The element body 3 includes ridge portions located between the side surfaces 3e and the side surfaces 3a, and ridge portions located between one of the first pair of side surfaces 3a and one of the second pair of side surfaces 3a. For example, each ridge portion is rounded to be curved. The element body 3 is subjected to a so-called R-chamfering process. The side surface 3e and the side surface 3a are indirectly adjacent to each other via the ridge portion located between the side surface 3e and the side surface 3a. One of the first pair of side surfaces 3a and one of the second pair of side surfaces 3a are indirectly adjacent to each other via the ridge portion located between one of the first pair of side surfaces 3a and one of the second pair of side surfaces 3a.

As illustrated in FIG. 5, the element body 3 includes a plurality of element body layers 4. Each of the plurality of element body layers 4 may include an insulator layer. The element body 3 may include a plurality of electrical insulation layers. The plurality of element body layers 4 are laminated, for example, in the direction D2. The element body 3 is configured by laminating the plurality of element body layers 4. In the actual element body 3, the plurality of element body layers 4 may be integrated to such an extent that the boundaries between the layers are not visible, or may be integrated such that the boundaries between the layers are visible.

The plurality of element body layers 4 may include a magnetic material. The magnetic material includes, for example, a ferrite material. The ferrite material includes, for example, a Ni-Cu-Zn-based ferrite material, a Ni-Cu-Zn-Mg-based ferrite material, a Cu-Zn-based ferrite material, or a Ni-Cu-based ferrite material. The plurality of element body layers 4 may include an Fe alloy. The plurality of element body layers 4 may include a non-magnetic material. The non-magnetic material includes, for example, a glass ceramic material or a dielectric material. The plurality of element body layers 4 may include a resin material.

As illustrated in FIGS. 2 - 5, the coil component 1 includes a plurality of coil conductors 10. Coil conductors 10 adjacent to each other, among the plurality of coil conductors 10, are electrically connected to each other. The electrical connection between the coil conductors 10 is established, for example, by an indirect connection through a connection conductor 11. The coil component 1 includes a plurality of connection conductors 11. The electrical connection between the coil conductors 10 may be established by a direct connection between the coil conductors 10. The plurality of coil conductors 10 electrically connected to each other constitute a coil 13 having a helical shape. The coil component 1 includes a coil 13 disposed in the element body 3. The coil 13 includes an internal conductor disposed within the element body 3. The plurality of coil conductors 10 are included in the internal conductor included in the coil 13.

The plurality of coil conductors 10 include a pair of coil conductors 10 each including one end exposed at a corresponding side surface 3e of the pair of side surfaces 3e. The pair of coil conductors 10 each including one end exposed at the corresponding side surface 3e are located at both ends of the coil 13.

The plurality of coil conductors 10 and the plurality of connection conductors 11 include an electrically conductive material. The plurality of coil conductors 10 and the plurality of connection conductors 11 are configured, for example, as sintered bodies of an electrically conductive paste including an electrically conductive material. The electrically conductive paste includes, for example, an electrically conductive material in powder form, and includes an organic binder and an organic solvent. The electrically conductive material included in the coil conductors 10 and the connection conductors 11 includes, for example, Ag, Pd, Au, Pt, Cu, Ni, Al, Mo, or W. The electrically conductive material included in the coil conductors 10 and the connection conductors 11 may include, for example, an Ag-Pd alloy, an Ag-Cu alloy, an Ag-Au alloy, or an Ag-Pt alloy.

The external electrodes 5 are disposed, as illustrated in FIG. 1, at both ends of the element body 3 in the direction D1. The external electrode 5 is disposed on the corresponding side surface 3e of the element body 3. For example, the external electrode 5 is disposed on the four side surfaces 3a and one side surface 3e. The external electrode 5 includes a plurality of electrode portions respectively disposed on corresponding side surfaces of the four side surfaces 3a and the one side surface 3e. The external electrodes 5 may be disposed on one side surface 3a and one side surface 3e.

The coil conductor 10 including one end exposed at the corresponding side surface 3e is connected to the external electrode 5 disposed on the corresponding side surface 3e at the one end exposed at the corresponding side surface 3e. The coil conductor 10 including one end exposed at the corresponding side surface 3e is electrically connected to a corresponding external electrode 5 of the pair of external electrodes 5. The pair of external electrodes 5 are electrically connected to the plurality of coil conductors 10, that is, to the coil 13.

The external electrodes 5 include, for example, a plurality of electrode layers. The plurality of electrode layers include, for example, a sintered metal layer disposed on the element body 3 and a plating layer disposed on the sintered metal layer. The plurality of electrode layers may include an electrically conductive resin layer disposed between the sintered metal layer and the plating layer.

The plurality of coil conductors 10 each extend along a different plane PL. The plane PL is, for example, substantially orthogonal to the direction D2 and substantially parallel to the direction D1 and the direction D3. The fact that the coil conductor 10 extends along the plane PL does not necessarily mean that the entirety of the coil conductor 10 is completely parallel to the plane PL. The coil conductor 10 only needs to extend generally along the plane PL, and the coil conductor 10 may include a portion that is not parallel to the plane PL.

As illustrated in FIG. 6, each of the plurality of coil conductors 10 includes a pair of main surfaces 10a and a pair of side surfaces 10c, in a cross-section orthogonal to the extending direction of the coil conductor 10. The cross-section orthogonal to the extending direction of the coil conductor 10 includes, for example, a cross-section orthogonal to the plane PL. The pair of main surfaces 10a oppose each other in a direction orthogonal to the plane PL. The pair of main surfaces 10a oppose each other, for example, in the direction D2. Each of the pair of side surfaces 10c couples the pair of main surfaces 10a to each other. A pair of coil conductors 10, among the plurality of coil conductors 10, adjacent to each other are connected to the connection conductor 11 on a side of one main surface 10a of the pair of main surfaces 10a. In each of the pair of coil conductors 10 adjacent to each other, the one main surface 10a described above includes a region connected to the connection conductor 11.

Each of the pair of side surfaces 10c is in contact with the element body 3 in at least a part thereof. The element body 3 includes a surface 3_{cs} in contact with a corresponding side surface 10c of the pair of side surfaces 10c. A void may exist between the side surface 10c and the surface 3_{cs} corresponding to each other. In a configuration in which a void exists between the side surface 10c and the surface 3_{cs}, the side surface 10c and the surface 3_{cs} are, at the position of the void, spaced apart from and are not in contact with each other. Each of the pair of side surfaces 10c may be entirely in contact with the element body 3. That is, the side surface 10c and the surface 3_{cs} may be in contact with each other entirely or partially.

Each of the pair of side surfaces 10c and the surface 3_{cs} in contact with the corresponding side surface 10c have complementary uneven shapes in a cross-section orthogonal to the extending direction of the coil conductor 10. In the cross-section orthogonal to the extending direction of the coil conductor 10, a recess of the side surface 10c and a protrusion of the surface 3_{cs} correspond to each other. That is, in a cross-section orthogonal to the extending direction of the coil conductor 10, the side surface 10c and the surface 3_{cs} have shapes that correspond to each other. The side surface of the connection conductor 11 and a surface of the element body 3 in contact with the side surface of the connection conductor 11 may have complementary uneven shapes in a cross-section orthogonal to the extending direction of the coil conductor 10. That is, in a cross-section orthogonal to the extending direction of the coil conductor 10, the side surface of the connection conductor 11 and a surface of the element body 3 in contact with the side surface of the connection conductor 11 may have shapes that correspond to each other.

As illustrated in FIGS. 2 - 6, the coil component 1 includes a stress relief portion 20 located within the element body 3. The stress relief portion 20 is in contact with the internal conductor included in the coil 13. The stress relief portion 20 is located between the element body 3 and the internal conductor. The stress relief portion 20 is configured to relieve internal stress generated in the element body 3. That is, the stress relief portion 20 is configured to relieve internal stress in the element body 3.

The stress relief portion 20 includes a pair of stress relief regions 21. Each of the pair of stress relief regions 21 is in contact with a corresponding main surface 10a of the pair of main surfaces 10a included in the coil conductor 10. The pair of stress relief regions 21 are disposed on one coil conductor 10. The stress relief region 21 is located between the element body 3 and the main surface 10a of the coil conductor 10. In the coil component 1, the pair of stress relief regions 21 are in contact with each of the plurality of coil conductors 10. That is, the stress relief portion 20 includes a plurality of pairs of stress relief regions 21. The plurality of stress relief regions 21 are disposed in pairs, each corresponding to one of the plurality of coil conductors 10.

Each of the pair of stress relief regions 21 extends along the corresponding main surface 10a. The stress relief region 21 extends along the coil conductor 10. Each of the pair of stress relief regions 21 covers the corresponding main surface 10a.

The stress relief region 21 leaves the main surface 10a exposed in a region connected to the connection conductor 11. The region of the main surface 10a connected to the connection conductor 11 is not covered by the stress relief region 21 and is not in contact with the stress relief region 21. Therefore, the connection conductor 11 is directly connected to the coil conductor 10.

The main surface 10a that opposes the main surface 10a that includes the region connected to the connection conductor 11 and that does not include the region connected to the connection conductor 11 includes a region corresponding to the connection conductor 11. The stress relief region 21 in contact with the main surface 10a that does not include the region connected to the connection conductor 11 is in contact with the region corresponding to the connection conductor 11. The stress relief region 21 covers the region corresponding to the connection conductor 11.

Each of the pair of coil conductors 10 located at both ends of the coil 13 includes the one end exposed at the side surface 3e and includes a connection region connected to the corresponding external electrode 5. For example, the stress relief region 21 is not in contact with the connection region included in each of the pair of coil conductors 10 located at both ends of the coil 13. The pair of main surfaces 10a are in contact with the element body 3 in the connection region. The stress relief region 21 is not exposed at the side surface 3e.

For example, the pair of stress relief regions 21 in contact with the pair of main surfaces 10a included in the coil conductor 10 have equivalent widths. The width of the stress relief region 21 is defined, for example, by the length in a direction orthogonal to a direction in which the pair of main surfaces 10a oppose each other in a cross-section orthogonal to the extending direction of the coil conductor 10.

The width of the stress relief region 21 may be equivalent to the width of the coil conductor 10. The width of the coil conductor is defined, for example, by the maximum length in a direction orthogonal to the direction in which the pair of main surfaces 10a oppose each other in a cross-section orthogonal to the extending direction of the coil conductor 10.

In this specification, the term "equivalent" does not necessarily mean that a plurality of values strictly coincide with each other. The plurality of values may be considered to be equivalent even when they include slight differences within a predetermined range, manufacturing errors, or measurement errors. For example, when each of a plurality of values falls within a range of ±5 % of an average value of the plurality of values, the plurality of values are defined as being equivalent.

The stress relief portion 20, that is, the stress relief region 21, includes ZrO₂. For example, the stress relief region 21 includes ZrO₂ in powder form. The stress relief region 21 is, for example, a space including ZrO₂ powder. ZrO₂ has a melting point higher than a melting point of the material included in the element body 3. The melting point of ZrO₂ is higher than the melting point of the ferrite material. An average particle diameter of the ZrO₂powder is, for example, from 0.1 to 1.0 μm. The stress relief region 21 is configured, for example, by firing a paste including ZrO₂ in powder form. The paste including ZrO₂ in powder form includes, for example, an organic binder and an organic solvent. A void may exist in the stress relief region 21. The thickness of the stress relief region 21 is, for example, from 1.0 to 20 μm.

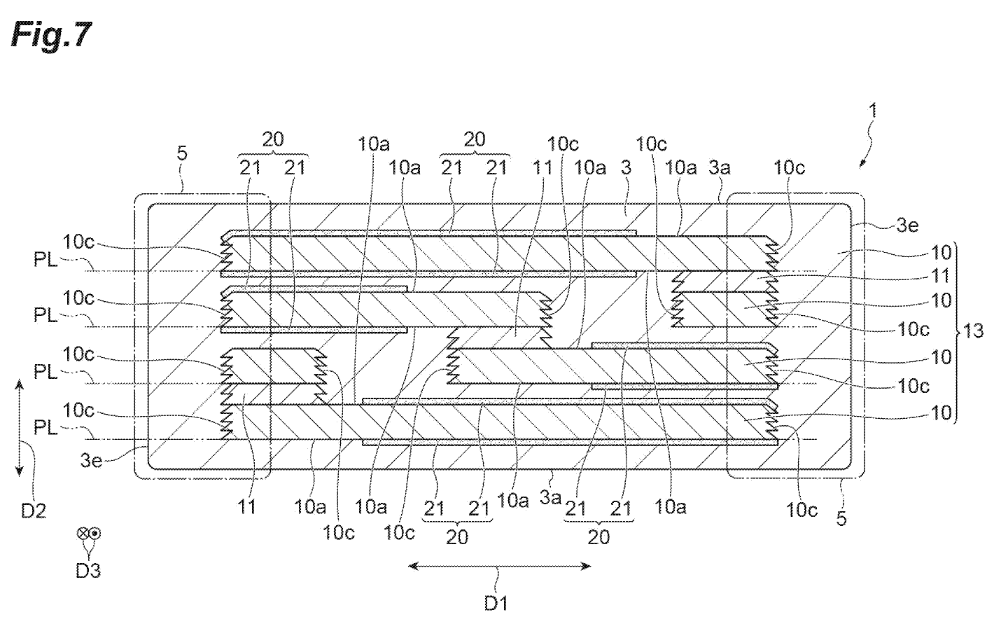

As illustrated in FIG. 7, the stress relief region 21 in contact with the main surface 10a that does not include the region connected to the connection conductor 11 need not be in contact with the region corresponding to the connection conductor 11. The stress relief region 21 need not cover the region corresponding to the connection conductor 11. The stress relief portion 20 may expose the region corresponding to the connection conductor 11. The region corresponding to the connection conductor 11 may be in contact with the element body 3.

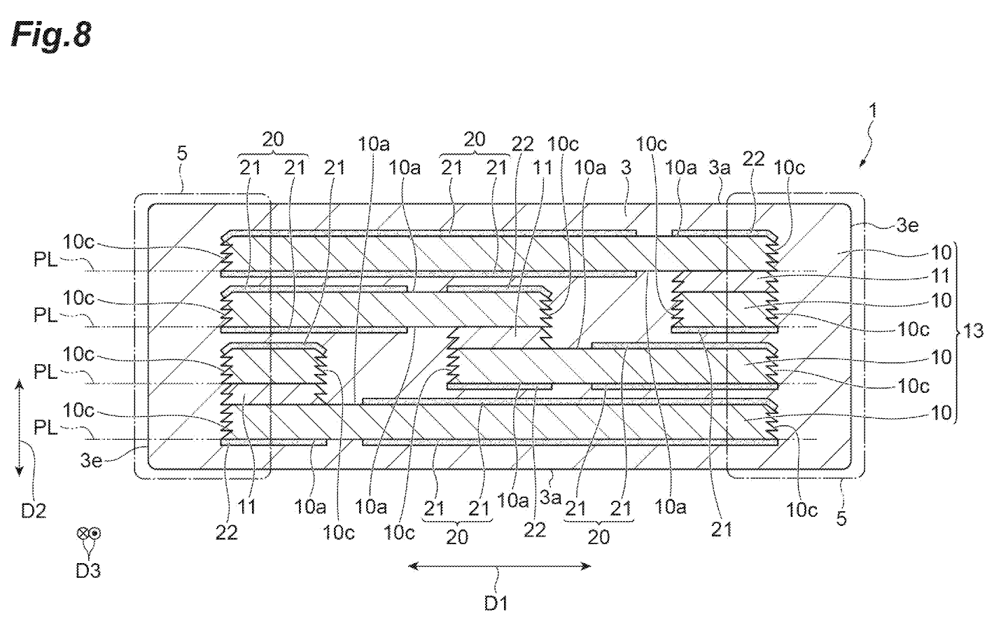

As illustrated in FIG. 8, the region corresponding to the connection conductor 11 may be in contact with a stress relief region 22 other than the stress relief region 21. On the main surface 10a that does not include the region connected to the connection conductor 11, the stress relief region 21 and the stress relief region 22 may be spaced apart from each other. For example, the stress relief region 22 includes ZrO₂, similarly to the stress relief region 21. For example, the stress relief region 22 includes ZrO₂in powder form. The stress relief region 22 is, for example, a space including ZrO₂ powder. A void may exist in the stress relief region 22. The thickness of the stress relief region 22 is, for example, from 1.0 to 20 μm.

FIGS. 7 and 8 are views illustrating cross-sectional configurations of coil components according to modifications of the example.

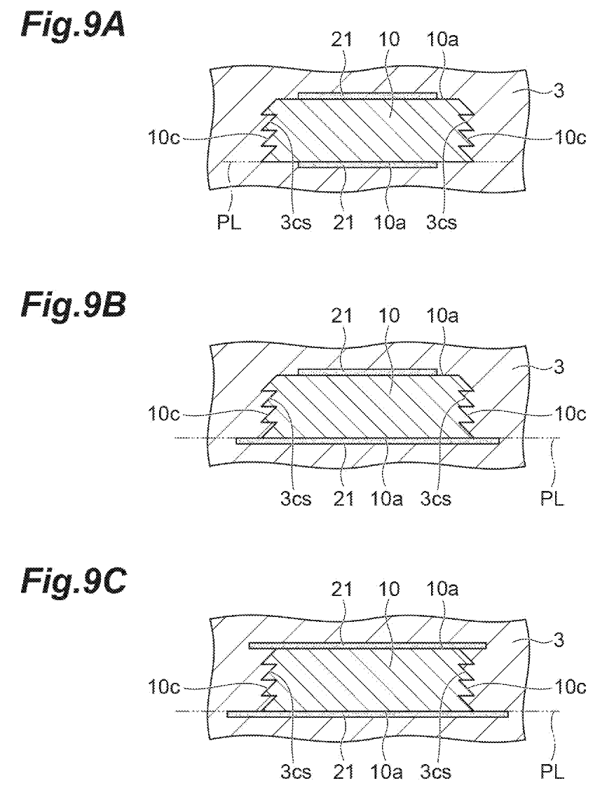

As illustrated in FIG. 9A, the width of the stress relief region 21 may be smaller than the width of the coil conductor 10. In a configuration in which the width of the stress relief region 21 is smaller than the width of the coil conductor 10, the main surface 10a includes, in a cross-section orthogonal to the extending direction of the coil conductor 10, a region covered by the stress relief region 21 and a region left bare by the stress relief region 21. The region covered by the stress relief region 21 is in contact with the stress relief region 21. The region left bare by the stress relief region 21 is in contact with the element body 3.

As illustrated in FIGS. 9B and 9C, the pair of stress relief regions 21 in contact with the same coil conductor 10 may each have a different width. The width of the stress relief region 21 may be larger than the width of the coil conductor 10.

FIGS. 9A - 9C are views illustrating cross-sectional configurations of coil conductors.

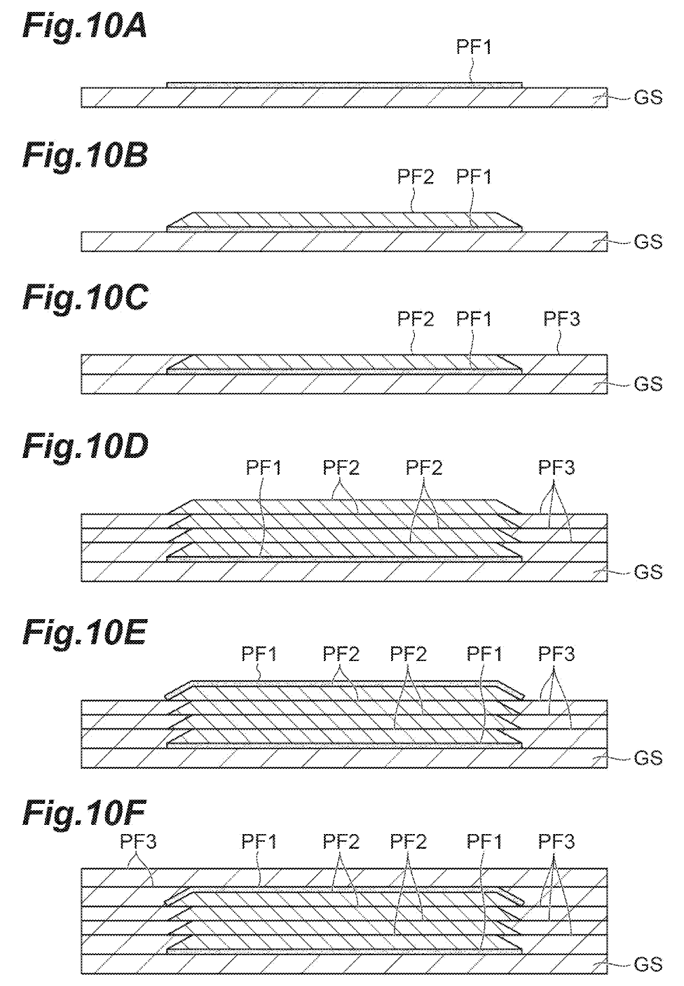

A manufacturing process of the coil component 1 may include a laminating process illustrated in FIGS. 10A - 10F. The side surface 10c and the surface 3_{cs} having the uneven shape described above can be obtained, for example, through the laminating process illustrated in FIGS. 10A - 10F. In addition to the laminating process, the manufacturing process of the coil component 1 includes, for example, a process of firing an unfired laminate obtained through the laminating process, and a process of forming external electrodes on the fired laminate. FIGS. 10A - 10F are schematic views illustrating an example of a manufacturing process of a coil component.

As illustrated in FIG. 10A, the paste described above for obtaining the stress relief region 21 is applied to a green sheet GS for forming the element body layer 4, thereby forming a paste film PF1. A planar shape of the paste film PF1 corresponds to a planar shape of the stress relief region 21. The process of forming the paste film PF1 may include, for example, a drying process.

Next, as illustrated in FIG. 10B, the electrically conductive paste described above is applied to the green sheet GS on which the paste film PF1 has been formed, thereby forming a conductive paste film PF2. The conductive paste film PF2 is formed on the paste film PF1 so as to overlap the paste film PF1. A planar shape of the conductive paste film PF2 corresponds, for example, to a planar shape of the coil conductor 10. The process of forming the conductive paste film PF2 may include, for example, a drying process.

Next, as illustrated in FIG. 10C, an element body material paste for forming the element body layer 4 is applied to the green sheet GS on which the conductive paste film PF2 has been formed, thereby forming an element body material paste film PF3. The element body material paste film PF3 is formed on the green sheet GS so as to partially overlap the edge of the conductive paste film PF2. The process of forming the element body material paste film PF3 may include, for example, a drying process.

Thereafter, as illustrated in FIG. 10D, the forming of the conductive paste film PF2 and the forming of the element body material paste film PF3 are repeated. A laminate including a plurality of conductive paste films PF2 and a plurality of element body material paste films PF3 is obtained. In the process illustrated in FIG. 10D as well, the element body material paste film PF3 is formed so as to partially overlap the edge of the conductive paste film PF2. Therefore, in the obtained laminate, the interface between the conductive paste film PF2 and the element body material paste film PF3 has an uneven shape.

As illustrated in FIG. 10E, the paste film PF1 is formed on the conductive paste film PF2. Thereafter, as illustrated in FIG. 10F, the element body material paste film PF3 is formed so as to partially overlap the edge of the paste film PF1.

In the laminating process described above, the element body material paste film PF3 is formed so as to partially overlap the edge of the conductive paste film PF2. Therefore, in the fired laminate, the side surface 10c and the surface 3_{cs} have the uneven shape described above. The green sheet GS may include the element body material paste film PF3.

As described above, in the coil component 1, the stress relief portion 20 includes the pair of stress relief regions 21. Each of the pair of stress relief regions 21 is in contact with the corresponding one of the pair of main surfaces 10a of the coil conductor 10 included in the internal conductor. Each of the pair of side surfaces 10c is, at least in part, in contact with the element body 3.

In a coil component including the element body 3 and the coil 13, cracks may occur in the element body 3 due to internal stress generated in the element body 3. The internal stress is generated, for example, by shrinkage of an internal conductor included in the coil 13 when the internal conductor is formed during the manufacturing process of the coil component. Due to the shrinkage of the internal conductor, a force in a direction in which the internal conductor pulls the element body 3 is generated in the element body 3.

In contrast, in the coil component 1, each of the pair of stress relief regions 21 is in contact with the corresponding main surface 10a. Therefore, on the main surface 10a side of the coil conductor 10, a force in a direction in which the coil conductor 10 pulls the element body 3 tends not to be generated in the element body 3. Consequently, the coil component 1 reduces the internal stress in the element body 3 and suppresses occurrence of cracks in the element body 3.

The shrinkage of the internal conductor described above may affect a cross-sectional area of the internal conductor. That is, the cross-sectional area of the internal conductor may decrease. A decrease in a cross-sectional area of the internal conductor increases direct current resistance of the coil 13.

In contrast, in the coil component 1, each of the pair of side surfaces 10c of the coil conductor 10 included in the internal conductor is, at least in part, in contact with the element body 3. The element body 3 tends to constrain the shrinkage of the coil conductor 10 in the region in contact with the coil conductor 10. Therefore, the coil component 1 suppresses the shrinkage of the coil conductor 10 in a direction intersecting the side surfaces 10c, thereby suppressing a decrease in the cross-sectional area of the coil conductor 10. Consequently, the coil component 1 suppresses an increase in direct current resistance.

Each of the pair of side surfaces 10c may be entirely in contact with the element body 3.

A configuration in which each of the pair of side surfaces 10c is entirely in contact with the element body 3 increases an area of a region, in the element body 3, that is in contact with the coil conductor 10. An increase in the area of the region, in the element body 3, that is in contact with the coil conductor 10 enhances the tendency for the element body 3 to constrain the shrinkage of the coil conductor 10. Therefore, this configuration further suppresses the decrease in the cross-sectional area of the coil conductor 10 and further suppresses the increase in direct current resistance.

Each of the pair of side surfaces 10c and the surface 3_{cs} may have complementary uneven shapes in the cross-section orthogonal to the extending direction of the coil conductor 10.

In a configuration in which each of the pair of side surfaces 10c and the surface 3_{cs} have the uneven shape described above, the element body 3 tends to further constrain the shrinkage of the coil conductor 10. Therefore, this configuration further suppresses the decrease in the cross-sectional area of the coil conductor 10 and further suppresses the increase in direct current resistance.

The coil component 1 may include the plurality of coil conductors 10 each extending along the different plane PL and each including the pair of main surfaces 10a and the pair of side surfaces 10c. Adjacent coil conductors 10 of the plurality of coil conductors 10 may be each connected to the connection conductor 11 on a side of one main surface 10a. The stress relief region 21 in contact with the other main surface 10a may be in contact with a region that corresponds to the connection conductor 11 and that is included in the other main surface 10a.

The connection conductor 11 also shrinks during the manufacturing process of the coil component 1, similarly to the coil conductor 10. Therefore, the region that corresponds to the connection conductor 11 and that is included in the other main surface 10a tends to cause a larger force to be generated in the element body 3 in a direction in which the conductor pulls the element body 3, compared to regions that are other than the region that corresponds to the connection conductor 11 and that are included in the other main surface 10a.

A configuration in which the stress relief portion 20 is in contact with the region corresponding to the connection conductor 11 reliably reduces the internal stress in the element body 3. Therefore, this configuration reliably suppresses the occurrence of cracks in the element body 3.

The stress relief portion 20 may include the stress relief region 22 in contact with a region that corresponds to the connection conductor 11 and that is included in the other main surface 10a.

As described above, a region that corresponds to the connection conductor 11 and that is included in the other main surface 10a tends to cause a larger force to be generated in the element body 3 in a direction in which the conductor pulls the element body 3, compared to regions that are other than the region that corresponds to the connection conductor 11 and that are included in the other main surface 10a.

A configuration in which the stress relief portion 20 includes the stress relief region 22 in contact with the region corresponding to the connection conductor 11 reliably reduces the internal stress in the element body 3. Therefore, this configuration reliably suppresses the occurrence of cracks in the element body 3.

The region that corresponds to the connection conductor 11 and that is included in the other main surface 10a need not be in contact with the stress relief portion 20. For example, the region that corresponds to the connection conductor 11 and that is included in the other main surface 10a need not be in contact with the stress relief region 21. For example, the region that corresponds to the connection conductor 11 and that is included in the other main surface 10a need not be in contact with the stress relief region 22.

A configuration in which the region corresponding to the connection conductor 11 is not in contact with the stress relief portion 20 increases the region, in the element body 3, that is in contact with the coil conductor 10. This configuration increases the region that constrains the shrinkage of the coil conductor 10. Therefore, this configuration further suppresses the decrease in the cross-sectional area of the coil conductor 10 and further suppresses the increase in direct current resistance.

The pair of stress relief regions 21 in contact with the same coil conductor 10 may have different widths from each other.

In a configuration in which the pair of stress relief regions 21 in contact with the same coil conductor 10 have the same width, a position of an end of the stress relief region 21 in contact with one main surface 10a and a position of an end of the stress relief region 21 in contact with the other main surface 10a tend to coincide with each other, in a view along a direction orthogonal to the plane PL. In a configuration in which the positions of the respective ends of the pair of stress relief regions 21 coincide with each other, cracks may occur in the element body 3 between the ends of the pair of stress relief regions 21.

In contrast, in a configuration in which the pair of stress relief regions 21 in contact with the same coil conductor 10 have different widths from each other, the positions of the respective ends of the pair of stress relief regions 21 tend not to coincide with each other, in a view along a direction orthogonal to the plane PL. Therefore, this configuration further suppresses the occurrence of cracks in the element body 3.

The stress relief portion 20 may include ZrO₂.

ZrO₂ has a high melting point and tends to exist in powder form. A configuration in which the stress relief portion 20 includes ZrO₂ reliably relieves the internal stress in the element body 3.

The element body 3 may include a ferrite material.

In a configuration in which the element body 3 includes a ferrite material, magnetic characteristics may change due to internal stress in the element body 3. The coil component 1 reduces the internal stress in the element body 3, as described above. Therefore, even in a configuration in which the element body 3 includes a ferrite material, the magnetic characteristics tend not to change.

It is to be understood that not all aspects, advantages and features described herein may necessarily be achieved by, or included in, any one particular example. Indeed, having described and illustrated various examples herein, it should be apparent that other examples may be modified in arrangement and detail.

Each of the pair of side surfaces 10c and the surface 3_{cs} in contact with the corresponding side surface 10c need not have complementary uneven shapes in a cross-section orthogonal to the extending direction of the coil conductor 10. In a cross-section orthogonal to the extending direction of the coil conductor 10, the coil conductor 10 may have a substantially rectangular shape or a substantially trapezoidal shape.

The number of turns of the coil 13 is not limited to the number illustrated in the drawings. The number of the plurality of coil conductors 10 is not limited to the number illustrated in the drawings. The number of the plurality of element body layers 4 is not limited to the number illustrated in the drawings. The shapes of the plurality of coil conductors 10 are not limited to the shapes illustrated in the drawings. The shapes of the plurality of connection conductors 11 are not limited to the shapes illustrated in the drawings.

What is claimed is:

1. A coil component comprising:
an element body;
a coil disposed in the element body and including an internal conductor that extends along a plane; and
a stress relief portion in contact with the internal conductor, located within the element body, and configured to relieve internal stress in the element body,
wherein the internal conductor includes, in a cross-section orthogonal to an extending direction of the internal conductor, a pair of main surfaces opposing each other in a direction orthogonal to the plane, and a pair of side surfaces extending between the pair of main surfaces,
wherein the stress relief portion includes a pair of stress relief regions each in contact with a corresponding main surface of the pair of main surfaces, and
wherein each of the pair of side surfaces is, at least in part, in contact with the element body.

2. The coil component according to claim 1,
wherein each of the pair of side surfaces is entirely in contact with the element body.

3. The coil component according to claim 1,
wherein each of the pair of side surfaces and a surface of the element body in contact with a corresponding side surface of the pair of side surfaces have complementary uneven shapes in the cross-section orthogonal to the extending direction of the internal conductor.

4. The coil component according to claim 1,
wherein the internal conductor includes a plurality of coil conductors each extending along a different plane and each including the pair of main surfaces and the pair of side surfaces,
wherein adjacent coil conductors of the plurality of coil conductors are each connected to a connection conductor on a side of one main surface of the pair of main surfaces, and
wherein the stress relief portion includes a stress relief region in contact with a region that corresponds to the connection conductor and that is included in the other main surface of the pair of main surfaces.

5. The coil component according to claim 1,
wherein the internal conductor includes a plurality of coil conductors each extending along a different plane and each including the pair of main surfaces and the pair of side surfaces,
wherein adjacent coil conductors of the plurality of coil conductors are each connected to a connection conductor on a side of one main surface of the pair of main surfaces, and
wherein the stress relief region in contact with the other main surface of the pair of main surfaces is in contact with a region that corresponds to the connection conductor and that is included in the other main surface.

6. The coil component according to claim 1,
wherein the internal conductor includes a plurality of coil conductors each extending along a different plane and each including the pair of main surfaces and the pair of side surfaces,
wherein adjacent coil conductors of the plurality of coil conductors are each connected to a connection conductor on a side of one main surface of the pair of main surfaces, and
wherein a region that corresponds to the connection conductor and that is included in the other main surface of the pair of main surfaces is not in contact with the stress relief region.

7. The coil component according to claim 1,
wherein the pair of stress relief regions have different widths from each other.

8. The coil component according to claim 1,
wherein the stress relief portion includes ZrO₂.

9. The coil component according to claim 1,
wherein the element body includes a ferrite material.

10. The coil component according to claim 1,
wherein each of the pair of side surfaces and a surface of the element body in contact with a corresponding side surface of the pair of side surfaces have mutually corresponding uneven shapes in the cross-section orthogonal to the extending direction of the internal conductor.

11. A coil component comprising:
an element body;
a coil disposed in the element body and including an internal conductor that extends along a plane; and
a pair of regions including ZrO₂ powder and located within the element body,
wherein the internal conductor includes, in a cross-section orthogonal to an extending direction of the internal conductor, a pair of main surfaces opposing each other in a direction orthogonal to the plane, and a pair of side surfaces extending between the pair of main surfaces,
wherein the pair of regions are each in contact with a corresponding main surface of the pair of main surfaces, and
wherein each of the pair of side surfaces is, at least in part, in contact with the element body.

12. The coil component according to claim 11,
wherein each of the pair of side surfaces is entirely in contact with the element body.

13. The coil component according to claim 11,
wherein each of the pair of side surfaces and a surface of the element body in contact with a corresponding side surface of the pair of side surfaces have mutually corresponding uneven shapes in the cross-section orthogonal to the extending direction of the internal conductor.

14. The coil component according to claim 11, further comprising:
a region other than the pair of regions, including ZrO₂ powder, and located within the element body,
wherein the internal conductor includes a plurality of coil conductors each extending along a different plane and each including the pair of main surfaces and the pair of side surfaces,
wherein adjacent coil conductors of the plurality of coil conductors are each connected to a connection conductor on a side of one main surface of the pair of main surfaces, and
wherein the region other than the pair of regions is in contact with a region that corresponds to the connection conductor and that is included in the other main surface of the pair of main surfaces.

15. The coil component according to claim 11,
wherein the internal conductor includes a plurality of coil conductors each extending along a different plane and each including the pair of main surfaces and the pair of side surfaces,
wherein adjacent coil conductors of the plurality of coil conductors are each connected to a connection conductor on a side of one main surface of the pair of main surfaces, and
wherein the region in contact with the other main surface of the pair of main surfaces is in contact with a region that corresponds to the connection conductor and that is included in the other main surface.

16. The coil component according to claim 11,
wherein the internal conductor includes a plurality of coil conductors each extending along a different plane and each including the pair of main surfaces and the pair of side surfaces,
wherein adjacent coil conductors of the plurality of coil conductors are each connected to a connection conductor on a side of one main surface of the pair of main surfaces, and
wherein a region that corresponds to the connection conductor and that is included in the other main surface of the pair of main surfaces is in contact with the element body.

17. The coil component according to claim 11,
wherein the pair of regions have different widths from each other.

18. The coil component according to claim 11,
wherein the element body includes a ferrite material.
